(19) United States
(12) Patent Application Publication
(10) Pub. No.: US 2023/0018069 A1
(43) Pub. Date: Jan. 19, 2023

(54) STATOR FOR AN ELECTRICAL MACHINE, ELECTRICAL MACHINE, AND VEHICLE

(71) Applicant: Valeo Siemens eAutomotive Germany GmbH, (US)

(72) Inventor: Christian Finger-Albert, Bad Kissingen (DE)

(73) Assignee: Valeo Siemens eAutomotive Germany GmbH, Erlangen (DE)

(21) Appl. No.: 17/786,915

(22) PCT Filed: Dec. 10, 2020
(86) PCT No.: PCT/EP2020/085409

§ 371 Date: Jun. 17, 2022

(30) Foreign Application Priority Data
Dec. 19, 2019 (DE) 10 2019 135 138.3

(51) Int. Cl. H02K 3/34

(52) U.S. Cl. CPC H02K 3/345

(57) ABSTRACT

Stator for an electrical machine, comprising a stator core with stator slots which are formed along an axial direction with respect to a center axis of the stator and are arranged in a manner distributed in a circumferential direction with respect to the center axis, a hairpin winding with a large number of hairpin element arrangements which are arranged in the stator slots and each emerge from the end side of the stator core, and at least one insulation apparatus with a body in which a large number of passage openings which are arranged in a manner distributed in the circumferential direction are formed; wherein a respective hairpin element arrangement passes through one of the passage openings and the insulation apparatus specifies a distance of the hairpin element arrangement from an edge of the stator slot which receives the hairpin element arrangement.

The present invention relates to a stator for an electrical machine, comprising a stator core with stator slots which are formed along an axial direction with respect to a center axis of the stator and are arranged in a manner distributed in a circumferential direction with respect to the center axis; and a hairpin winding with a multiplicity of hairpin element arrangements which are arranged in the stator slots and each emerge from the end face of the stator core.

In addition, the invention relates to an electrical machine and to a vehicle.

Stators with a hairpin winding have become the focus of industrial development efforts, in particular in the field of electrical drives for vehicles. In comparison to distributed windings, they permit in particular a substantially automated manufacturing process because it is possible to dispense with a complicated drawing in of windings formed from thin wires.

The document DE 10 2017 201 533 A1 discloses a stator for an electrical machine, comprising an annular laminated core with a longitudinal axis and with a plurality of slots each extending along the longitudinal axis, a plurality of connecting wires which are designed as hairpins and are each arranged in the slots forming a ring, and an insulating layer of the slots, the insulating layer being arranged on the inner side thereof and being embodied as insulating paper.

In the case of stators of this type, the insulating paper serves not only as an electrical insulator, but also for positioning the hairpin element arrangements in the stator slots. For this purpose, the insulating paper is introduced into the stator slots and completely lines the stator slots. The hairpin element arrangements are then pushed into the stator slots, and therefore the insulating paper separates the hairpin element arrangements from the stator core. Typically, the arrangement formed in this manner is fixed by an impregnation process.

Disadvantages of stators of this type include the fact that the insulating paper permits only low positioning accuracy and in addition also forms a thermal insulator between the hairpin element arrangements and the stator core.

The invention is based on the object of specifying an improved possibility for arranging a hairpin winding in a stator core.

According to the invention, in order to achieve this object, a stator of the type mentioned at the beginning is proposed, furthermore comprising at least one insulating device with a body in which a multiplicity of passage openings arranged in a manner distributed in the circumferential direction are formed, wherein a respective hairpin element arrangement passes through one of the passage openings and the insulating device predefines a distance of the hairpin element arrangement from an edge of the stator slot receiving the hairpin element arrangement.

The invention is based on the consideration of realizing a defined position of the hairpin element arrangements within a respective stator slot by means of the insulating device, the passage openings of which predefine the position of the hairpin element arrangements in relation to the stator slots. It is possible here to dispense with conventionally used insulating paper which has to be introduced into the stator slots in a complicated way in individual working steps. The electrical insulation of the hairpin winding in relation to the stator core is ensured, in the case of the stator according to the invention, by the distance predefined by the insulating device.

A hairpin winding within the meaning of the present invention is a winding which is formed from substantially rigid, optionally curved, molded conductors. In German, the term “Haarnadelwicklung” is known for “Hairpinwicklung” [hairpin winding], and therefore the German term “Hairpin” can be replaced, even in combinations of words, by the German term “Haarnadel” [hairpin].

The body of the insulating device is typically annular. A center axis of the insulating device preferably corresponds to the center axis of the stator.

Advantageously, provision can be made, in the case of the stator according to the invention, for an edge of a respective passage opening to have protrusions which point into the passage opening and predefine the distance. The protrusions here create suitable supporting points or supporting surfaces for the hairpin element arrangement in order to reliably predefine the distance thereof from the stator groove.

In the case of the stator according to the invention, it is furthermore preferred if each hairpin element arrangement has a plurality of hairpin elements which are arranged in the stator slot in a manner laminated in a lamination direction with respect to the center axis.

In an advantageous development, it can be provided that for a respective hairpin element of the hairpin element arrangement one of the protrusions is formed on an or on a respective edge portion of the passage opening, the edge portion extending along or parallel to the lamination direction. As a result, each hairpin element can be supported separately, in particular on both sides, for predefining the distance.

Alternatively or additionally, it can be provided that for a or a respective hairpin element of the hairpin element arrangement that is an outer hairpin element with respect to the lamination direction one of the protrusions is formed on an edge portion of the passage opening, the edge portion extending transversely with respect to the lamination direction. The hairpin element arrangement can thus be reliably supported along the lamination direction in order to predefine the distance.

The lamination direction typically runs along a radial direction with respect to the center axis of the stator.

In the case of the stator according to the invention, it is of particular advantage if a casting compound surrounding the hairpin element arrangements is arranged in the stator slots. As a result, heat produced during the operation of the electrical machine can be removed to the stator core via the casting compound. In comparison to conventional stators with an insulating paper which forms a thermal barrier between the hairpin winding and the stator core, heat dissipation from the hairpin winding can thus be considerably improved. The heat can namely be removed directly from the casting compound to the stator core. The improved heat dissipation increases the efficiency of the electrical machine, and in particular the continuous output thereof can be raised. The casting compound is preferably a cured resin.

Furthermore preferably, the casting compound can substantially completely fill and seal substantially without air a space between the stator slot and the hairpin element arrangements. The heat dissipation can thus be increased further. “Substantially” therefore means merely taking unintentional manufacturing tolerances into consideration.

Preferably, in the case of the stator according to the invention, an insulating device is arranged on an end face of the stator core. Such an insulating device can consequently also be regarded as a stator end plate.

In addition, an insulating device can be arranged on the other end face of the stator core opposite the first end face. The hairpin winding is thus supported on both sides in order to predefine the distance. Such an insulating device can also be regarded as stator end plate.

In addition, in the case of the stator according to the invention, it can be provided that the stator core is subdivided along the axial direction into at least two partial stator cores, an insulating device being arranged between a respective pair of adjacent partial stator cores. An additional tangential or radial support of the hairpin winding can thus be realized. A combined tangential and radial support can also be made possible.

The object on which the invention is based is furthermore achieved by an electrical machine comprising a stator according to the invention and a rotor arranged rotatably within the stator.

In addition, the object on which the invention is based is achieved by a vehicle comprising an electrical machine according to the invention which is configured to drive the vehicle.

Further advantages and details of the present invention emerge from the exemplary embodiments described below and with reference to the drawings. The latter are schematic illustrations and:

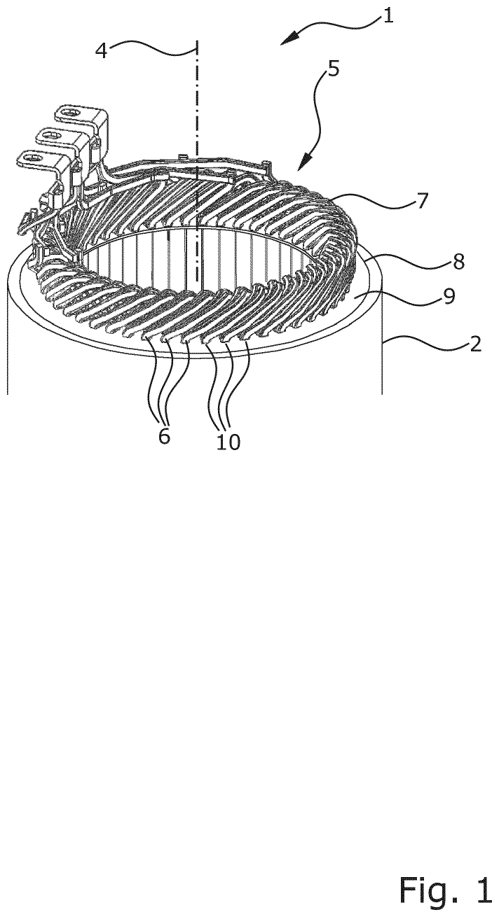

FIG. 1 shows a perspective view of an end face of a first exemplary embodiment of the stator according to the invention;

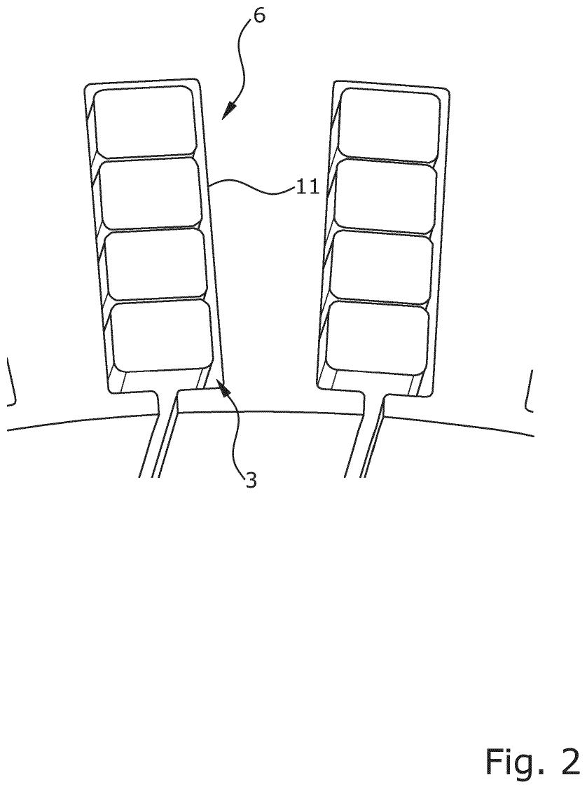

FIG. 2 shows a sectioned detailed view of the stator according to the first exemplary embodiment;

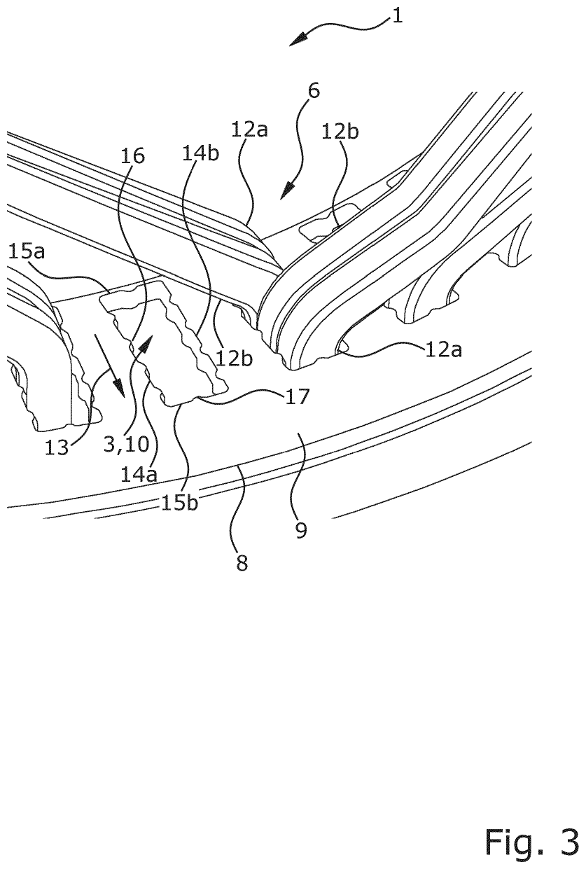

FIG. 3 shows a perspective detailed view of the stator according to the first exemplary embodiment;

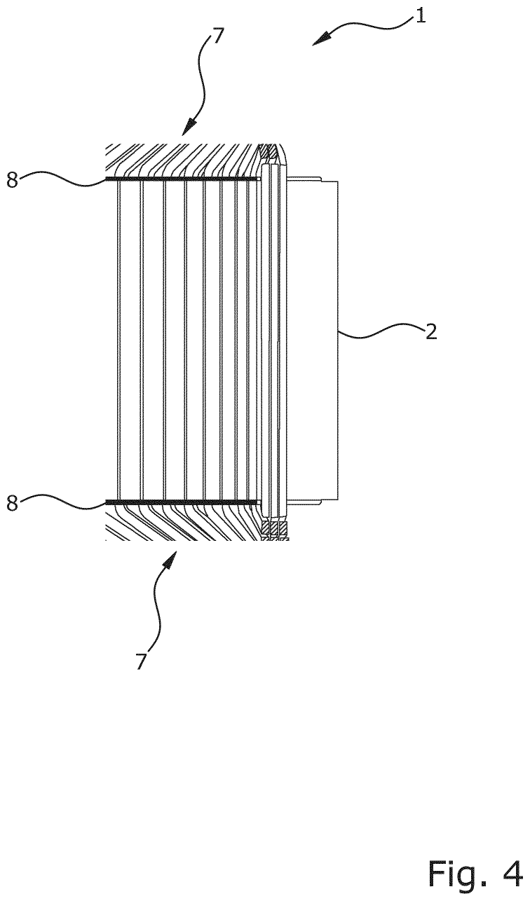

FIG. 4 shows a schematic diagram of a second exemplary embodiment of the stator according to the invention;

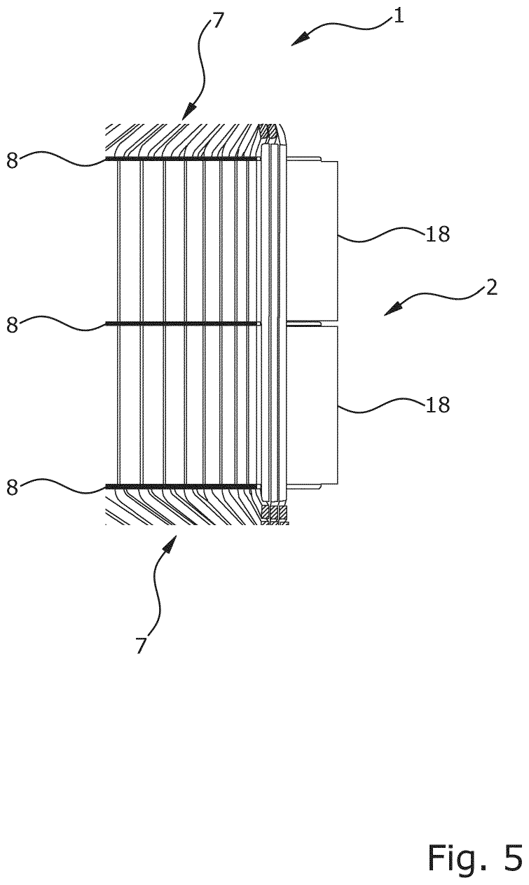

FIG. 5 shows a schematic diagram of a third exemplary embodiment of the stator according to the invention; and

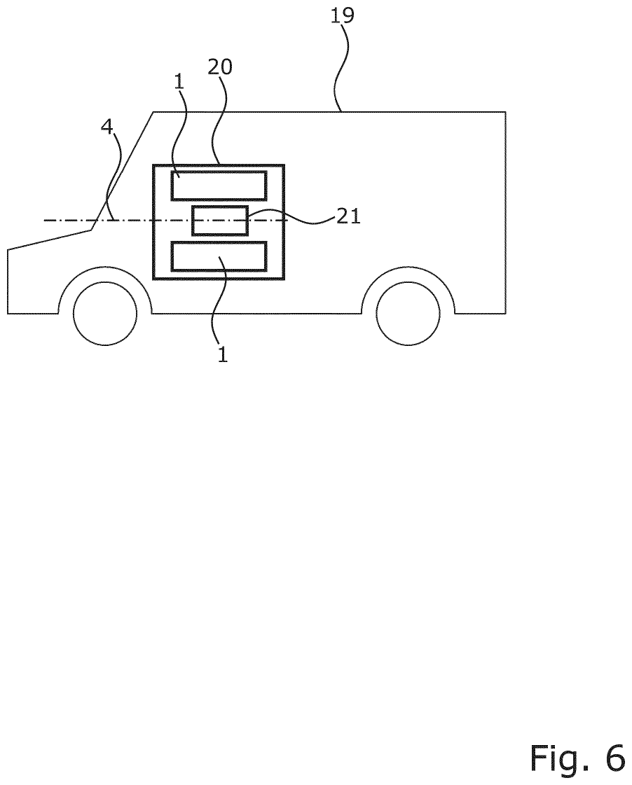

FIG. 6 shows a schematic diagram of an exemplary embodiment of the vehicle according to the invention with an exemplary embodiment of the electrical machine according to the invention.

FIG. 1 is a perspective view of an end face of a first exemplary embodiment of a stator 1.

The stator 1 comprises a stator core 2 with stator slots 3, which are concealed in FIG. 1 (see FIG. 2 and FIG. 3) and which are formed along an axial direction with respect to a center axis 4 of the stator. The stator slots 3 are arranged in the stator core 2 in a manner distributed in a circumferential direction with respect to the center axis 4.

In addition, the stator 1 comprises a hairpin winding 5 with a multiplicity of hairpin element arrangements 6 which are arranged in the stator slots 3 in a manner distributed in the circumferential direction and each emerge from the end face of the stator core 2. The hairpin winding 5 thus forms winding heads 7 on both end faces of the stator core 2.

An insulating device 8 is provided in the stator 1 according to the first exemplary embodiment. Said insulating device has an annular body 9 in which a multiplicity of passage openings 10 arranged in a manner distributed in the circumferential direction are formed. A respective hairpin element arrangement 6 passes through one of the passage openings 10.

FIG. 2 shows a sectioned detailed view of the stator 1 according to the first exemplary embodiment.

The insulating device 8 (see FIG. 1) predefines a distance of the hairpin element arrangement 6 from an edge 11 of the stator slot 3 receiving it.

FIG. 3 is a perspective detailed view of the stator 1 according to the first exemplary embodiment. Only one hairpin element arrangement 6, shown centrally in FIG. 3, is fully illustrated, whereas other stator slots 3 are illustrated unoccupied or only partially occupied, in order to be able to more accurately describe the insulating device 8.

Each hairpin element arrangement 6 comprises a plurality of hairpin elements 12a, 12b, four by way of example here, which are arranged in the stator slot 3 in a manner laminated in a lamination direction, symbolized by an arrow 13, with respect to the center axis 4 (see FIG. 1). Each passage opening 10 of the insulating device 8 comprises two edge portions 14a, 14b which extend along the lamination direction, and two edge portions 15a, 15b which extend transversely with respect to the lamination direction. For a respective hairpin element 12a, 12b of the hairpin element arrangement 6, a protrusion 16 is formed on each of the opposite edge portions 14a, 14b. In addition, for each outer hairpin element 12a with respect to the lamination direction, a protrusion 17 is provided on each of the edge portions 15a, 15b extending transversely with respect to the lamination direction.

Although not illustrated in FIG. 2 and FIG. 3 for clarity reasons, the stator slots 3 are filled with a casting compound surrounding the hairpin element arrangements 6. The casting compound is a cured resin.

In the following, further exemplary embodiments of a stator 1 are described, for which all of the statements regarding the first exemplary embodiment correspondingly apply except for the differences described below. Identical components or components acting in an identical manner are provided with identical reference signs.

FIG. 4 is a schematic diagram of a second exemplary embodiment of a stator 1. In this exemplary embodiment, two identical insulating devices 8 are arranged on both opposite end faces of the stator core 2.

FIG. 5 is a schematic diagram of a third exemplary embodiment of a stator 1. In this exemplary embodiment, the stator core 2 is subdivided into two partial stator cores 18. In addition to two insulating devices 8, which are arranged on the end faces, in accordance with the second exemplary embodiment, a further insulating device 8 is arranged between the adjacent partial stator cores 18, said insulating device being formed in a manner substantially corresponding to the two other insulating devices 8. Of course, the stator core 2 can also be subdivided into more than two partial stator cores 18, an insulating device 8 being provided between a respective adjacent pair of partial stator cores 18.

FIG. 6 is a schematic diagram of an exemplary embodiment of a vehicle 19 with an exemplary embodiment of an electrical machine 20. The electrical machine 20 is configured for driving the vehicle 19 and comprises a stator 1 according to one of the previously described exemplary embodiments, in which a rotor 21 is arranged rotatably. The vehicle is an electric vehicle (BEV) or a hybrid vehicle. As can be seen, the center axis 4 corresponds to the axis of rotation of the rotor 21.

1. A stator for an electrical machine, comprising:
a stator core with stator slots which are formed along an axial direction with respect to a center axis of the stator and are arranged in a manner distributed in a circumferential direction with respect to the center axis;
a hairpin winding with a multiplicity of hairpin element arrangements which are arranged in the stator slots and each emerge from the end face of the stator core; and
at least one insulating device with a body in which a multiplicity of passage openings arranged in a manner distributed in the circumferential direction are formed,
wherein a respective hairpin element arrangement passes through one of the passage openings and the insulating device predefines a distance of the hairpin element arrangement from an edge of the stator slot receiving the hairpin element arrangement.

2. The stator as claimed in claim 1, wherein an edge of a respective passage opening has protrusions which point into the passage opening and predefine the distance.

3. The stator as claimed in claim 2, wherein each hairpin element arrangement has a plurality of hairpin elements which are arranged in the stator slot in a manner laminated in a lamination direction with respect to the center axis.

4. The stator as claimed in claim 3, wherein for a respective hairpin element of the hairpin element arrangement one of the protrusions is formed on an or on a respective edge portion of the passage opening, the edge portion extending along or parallel to the lamination direction.

5. The stator as claimed in claim 3, wherein for a or a respective hairpin element of the hairpin element arrangement that is an outer hairpin element with respect to the lamination direction one of the protrusions is formed on an edge portion of the passage opening, the edge portion extending transversely with respect to the lamination direction.

6. The stator as claimed in claim 1, wherein a casting compound surrounding the hairpin element arrangements is arranged in the stator slots.

7. The stator as claimed in claim 1, wherein an insulating device is arranged on an end face of the stator core.

8. The stator as claimed in claim 7, wherein an insulating device is arranged on the other end face of the stator core opposite the first end face.

9. The stator as claimed in claim 1, wherein the stator core is subdivided along the axial direction into at least two partial stator cores, an insulating device being arranged between a respective pair of adjacent partial stator cores.

10. An electrical machine, comprising: a stator as claimed in claim 1; and a rotor which is arranged rotatably within the stator.

11. A vehicle, comprising: an electrical machine as claimed in claim 10, which is configured to drive the vehicle.
